(19) United States
(12) Patent Application Publication
(10) Pub. No.: US 2004/0236627 A1
(43) Pub. Date: Nov. 25, 2004

(54) Coupon discounts.com

(76) Inventors: Daniel Mark Abraham, Keuner, LA (US); Bernard J. Slutsky JR., Metairie, LA (US)

Correspondence Address: DAN ABRAHAM, 308 Pellerin Dr., Keuner, LA, 70065, US

(21) Appl. No.: 10/217,104

(22) Filed: Aug. 12, 2002

(51) Int. Cl. G06F 17/60

(52) U.S. Cl. 705/14

(57) ABSTRACT

An electronic Storefront (website approach) provided through the Internet, where specific brands or advertisers are provided proprietary departments (Stores) to promote any variety of product incentives, i.e. coupons, rebates, discounts etc . . . to specific regions. These all-electronic transactions and communication are maintained in the Storefront's proprietary database provide tracking and identification of selected incentives, printed out and redeemed, as well as any rebates automatically provided through the proprietary software program utilizing indigenous tracking numbers or household identification number to every transaction. All of this is accomplished in a redemption-based remuneration approach.

### FIELD OF THE INVENTION

### BACKGROUND OF THE INVENTION

With the variety of coupon sites popping up on the Internet, the web promises to be the coupon-marketing wave of the future. But Fraud is the main issue between issue between end users downloading and printing out offers when they chose and having to settle for offer provided by direct mail of Sunday newspaper insert.

The Internet provides a terrific resource with its speed and distribution ability but manufacturers have major issues with Web-based, printable incentive offers. With the average percentage of fraud being about 25% of redemption, the cost and the concern is great.

Package goods manufacturers have grave concerns regarding fraud on a retailer basis and the costs of production and distribution of conventional print couponing. Conventional approaches and existing inventions do not adequately address these concerns.

### SUMMARY OF THE INVENTION

The Internet with its speed and distribution capability seems to be ideally suited to assist in this exiting dilemma of conventional marketers. With the World Wide Web and other online services, target marketing to the masses is possible and affordable. Regardless of the product, the locale or the prospect. But redemption fraud is a major concern as is the expense of conventional mass marketing.

The Invention submitted, redefines target marketing. In the preferred embodiment, the invention provides an electronic means for Brands and Advertisers to display incentive offers online. Distributing offers in this manner allows them to control what is displayed, to whom and for how long. This storefront approach is maintained on the Inventors databases. Information contained is the property of the participating Stores (brand and advertisers). The issued “department” is proprietary. The Stores control access.

The invention incorporates some aspects of existing approaches. End users are provided printable, downloadable sales incentives, i.e. coupons, rebates or others. But the major consideration is providing detection of duplicate redemptions, for package goods and other incentive offers. The inventor has built a formidable target marketing approach with unparalleled production, maintenance and tracking capabilities, to that end.

The proprietary software and hardware, detailed in the invention, provides redemption facilities the availability to process and identify duplicates, which constitutes fraudulent usage. This also allows for remuneration for services to be based on redemption only, making this a true pay for performance model.

It is the object of this invention to eliminate duplicate redemptions of incentive offers submitted by unscrupulous end users, retailers or others, motivated by profiting on inflated, incentive print-out figures or inflated redemptions.

It is advantageous to this invention that specific sales incentives can be exhibited, via any online service such as the Internet, on the Storefront, by Stores (Brands or Advertisers).

It is also an advantage that these incentives are completely maintained by the Stores.

It is a feature of this invention that incentive specific information is included on each incentive offer for tracking purposes.

It is an advantage of this invention that routing equipment is attached to every scanning device.

It is also a feature of this invention that this equipment mirrors information retrieved from every offer that is scanned.

It is a feature that every offer scanned is then relayed to the Storefront's server where it is processed, identified and maintained.

It is a feature that once on the Storefront's server, it is deciphered, processed and identified to be valid or a duplicate (fraudulent).

The information remains available to the Stores, so as to properly redeem valid offers.

### BRIEF DESCRIPTION OF DRAWINGS

Drawing 1 is a block diagram illustrating the online marketing approach to exhibit sales incentives, including the end users, the Storefront and the Store.

Drawing 2 is a block diagram illustrating the approach to tracking and identifying duplicate incentive offers to prevent fraud, especially in packaged goods where a separate redemption facility must process and verify redemption offers. Included is the end user/Storefront/Store/Retailer/Redemption center

### DETAILED DESCRIPTION OF PREFERRED EMBODIMENTS

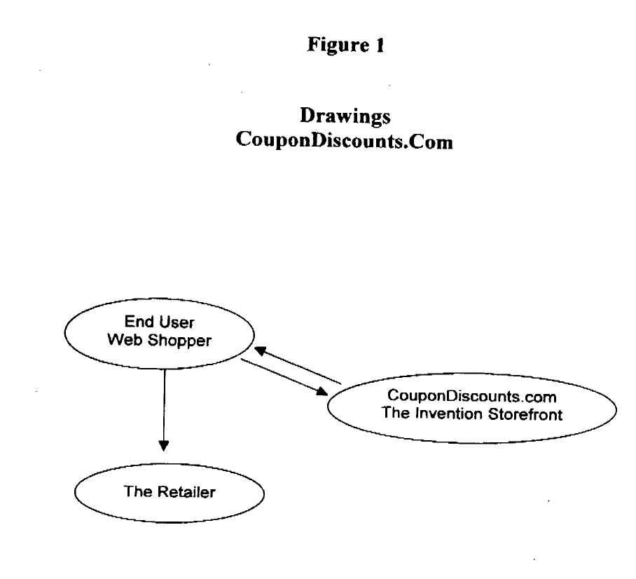

FIG. 1 generally illustrates Internet approach to exhibit sales incentives. The Storefront (The Internet web site) provides incentive offers provided by the Stores (Brands or Advertisers). The end users come to the Storefront, shop for offers and download the offers for printing.

Once printed, the end users take the incentive offers to retailers, where they are redeemed at the point of purchase. But they are not verified to be valid.

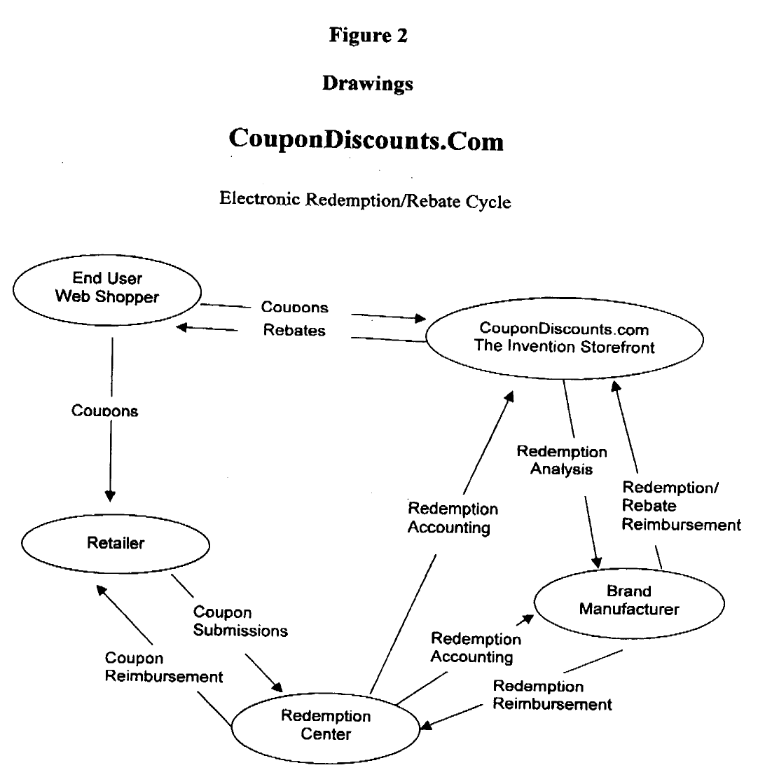

In practicality, duplicates can be provided at the point of purchase on the retail level, which will not be redeemed by the Store (the Brands or the Advertisers). These are fraudulent redemptions and are detailed in FIG. 2.

FIG. 2 generally illustrates the major consideration of the present invention. The approach primarily addresses consumer package goods incentive offers. The end-user shops the Storefront for incentive offers (coupons, rebates, discounts, credits etc . . . ) and prints out selected offers.

In theory, the end user then takes the printed offers to a Retailer. Once purchases of promoted products are made, and the incentive is presented for redemption at point of sale, the Retailer accepts the online offers, which have been printed out, online, and presented, and reimburses the end user, accordingly.

The Retailer then submits the offers to their redemption agent or directly to a redemption facility to be reimbursed. The redemption facility scans the offers into its data processing system.

At this point, the invention mirrors the scanned information and relays it to a host server, maintained by the Storefront. The host processes the data using proprietary software, which identifies and validates the coupon, utilizing its indigenous household identification number contained in its bar code. An accounting of all transactions is maintained for and accessible to Stores (the Brands or Advertisers) for verification and proper redemption, through this code.

It is from this verification that remuneration is made to the inventor and for providing the storefront department, which allows for the display and distribution of incentive offers on the invention. The end result is a true pay for performance vehicle. When the coupons or incentive offers are redeemed, the storefront is then compensated for providing this invention.

As will now be understood, the present invention, with its electronic system, detects and verifies duplicates sales incentive offers, which are submitted for redemption by unscrupulous end users, retailers or others, whose, motivation is profiting on inflated incentive print-out figures or inflated redemptions. These fraudulent submissions are submitted through retailers, to be processed at redemption centers for Brands and Advertisers. The present invention helps to identify, validate and maintain redemption offers, which should reimbursed to the retailers and thereby identifying fraudulent or duplicated offers.

The present invention also provides a unique electronic approach to marketing products online and utilizing a pay for performance model. Redemptions generate remuneration.

It will also be appreciated by those skilled in the art that variations and modifications may be made without departing from the spirit and scope of this invention.

1. An electronic, online Storefront approach provided to brand manufacturers and advertisers to target market specific incentive offers to specific regions, to verify and track fraudulently submitted incentive offers, subsequent to redemption, and to automatically, electronically provide rebates as building customer loyalty and acquire consumer demographics and psychographics, comprising of:
An Internet Storefront approach providing online target marketing by Stores (Brands and Advertisers) on a consignment basis being remunerated on redemption, not on a coupon printed or click thru basis; An electronic database to provide information and record all transactions; A proprietary routing software system, connecting deciphering redemption scanning and rebate information; A server maintaining all information, fully accessible to the Storefront as well as the Store.
I claim that specific departments are issued to contracting brands and advertisers (stores):
These departments are actually display areas controlled by the Stores, hosted on the Storefront.
Each Store's department is proprietary.
A variety of Stores may participate on the Storefront, and can provide an infinite number of items or categories.
Access into each department is gained through confidential passwords and login codes established and maintained by the Stores.
The Stores produce and submit their own offers to be displayed in their departments, showcased on the inventor's Internet website.
The Stores has the ability to maintain their own departments and their own displays.
The Stores determine how many offers are to made available daily; The Stores determine what regions are to receive what incentives. Incentive offers may be national, regional or local, in scope.
I claim that each offer displayed by a Store may contain indigenous information:
The Store name;
The item or brand name
The value of the incentive;
Disclaimers and modifiers for the incentive;
The origin of the incentive by zip code;
I claim that the incentives displayed in the Stores are viewed and selected by end users/web shoppers.
The incentives are free to the end user;
Are available twenty-four hours a day, seven days a week;
Viewable and printable by the end user, at their discretion;
Are printed on the end user's printer.
I claim that each printed incentive is identified and maintained in the proprietary back end database, by the Storefront.
I claim that the printed incentive offers may contain items referenced in # 4 and # 5 as well as the following:
Demographic information provided by the end user (web shopper) i.e. name, date of birth, sex, marital status, and other personal information.
Bar codes; An indigenous identification number or tracking code, which is logged into the Storefront's database for tracking and rebate purposes.
I further claim that the Storefront's database maintains all necessary information regarding the Stores, their departments, displays, links, rebates and customer accounts.
I claim that Activity Reports on incentive activity are available to the Stores though the Storefront's proprietary, backend database and software.
Activity reports provide the brands and advertisers tracking capability:
Where each item is displayed in their Store:
How many web shoppers saw the display (impressions);
How many web shoppers actually viewed the incentive offer;
How many web shoppers actually selected and printed out incentive offers;
How many incentives offers each the web shoppers actually selected and printed out;
Where the web shoppers are based;
Where the incentives were provided and redeemed;
From what regions web shoppers came;
What was the heaviest concentration of activity and when;
How large their loyalty base is on their Storefront.
I claim that these reports may be viewed online or printed out by the Store.

2. Identification and elimination of fraudulent submissions, as well as the automatic electronic rebates are accomplished by:
Tracking of impressions and print out activity for the incentives displayed by the Stores, and submitted to redemption facilities;
Indigenous identification numbers are printed on every incentive offer printed out through the Storefront.
Proprietary software is utilized at the redemption level to track activity on packaged goods as well as to determine rebate eligibility;
Information is retrieved at the time of the scanning the offers and accumulated as the incentives are processed by redemption facilities.
The system comparatively scans the data accumulated for duplicates.
The data extracted from the scan is accumulated, interpreted and Stored by the Storefront for use by the Stores.

3. Electronic rebates are automatically provided to shoppers by the brands, following the redemption process. The shopper receives the full value for the coupon offered as well as the rebate, once redemption has been established by the Storefront. In this way the shopper can be automatically rewarded for their loyalty by the brand(Store) and still obtain the full face value of any coupon offers provided through the
